(19) United States
(12) Patent Application Publication
(10) Pub. No.: US 2026/0323705 A1
(43) Pub. Date: Oct. 15, 2026

(54) RANDOM ACCESS PROCEDURE

(71) Applicant: Nokia Technologies Oy, Espoo (FI)

(72) Inventors: Marco MASO, Massy (FR); Alessio MARCONE, Munich (DE); Nhat-Quang NHAN, Massy (FR); Amir Mehdi AHMADIAN TEHRANI, Munich (DE); Arman AHMADZADEH, Munich (DE)

(21) Appl. No.: 19/106,814

(22) PCT Filed: Sep. 18, 2023
(86) PCT No.: PCT/EP2023/075568

§ 371 Date: Feb. 26, 2025

(30) Foreign Application Priority Data
Sep. 23, 2022 (FI) 20225824

(51) Int. Cl. H04W 74/0833; H04L 5/00

(52) U.S. Cl. CPC H04W 74/0833; H04L 5/0005

(57) ABSTRACT

In accordance with an example embodiment of the present disclosure there is provided an apparatus comprising means for performing: obtaining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions; using the repetition configuration to determine and select a sequence of ROs among the candidate sequences of ROs for transmission of the first message with repetitions; and using the selected sequence of ROs for transmission of the first message with repetitions.

### TECHNICAL FIELD

Various example embodiments relate to random access procedure of a mobile network.

### BACKGROUND

This section illustrates useful background information without admission of any technique described herein representative of the state of the art.

Random access procedure is used in mobile networks for initiating data transfer.

Present disclosure relates to development of random access procedure and more specifically to random access messages with repetitions.

### SUMMARY

The scope of protection sought for various embodiments of present disclosure is set out by the independent claims. The embodiments and features, if any, described in this specification that do not fall under the scope of the independent claims are to be interpreted as examples useful for understanding various example embodiments.

According to a first example aspect of the present disclosure, there is provided an apparatus comprising means for performing:
obtaining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions;
using the repetition configuration to determine and select a sequence of ROs among the candidate sequences of ROs for transmission of the first message with repetitions; and
using the selected sequence of ROs for transmission of the first message with repetitions.

In some example embodiments alone or in combination with other embodiments of different aspects of present disclosure, determining and selecting the sequence of ROs is performed by using the repetition configuration to determine the candidate sequences of ROs for transmission of the first message with repetitions; and selecting one of the determined candidate sequences of ROs.

In some example embodiments alone or in combination with other embodiments of different aspects of present disclosure, determining and selecting the sequence of ROs is performed by using the repetition configuration to determine one or more candidates for a first RO of the sequence and selecting one of the candidates as the first RO of the sequence; and iteratively determining one or more subsequent candidates for a subsequent RO of the sequence based on the previously selected RO of the sequence and selecting one of the subsequent candidates as the subsequent RO of the sequence until required number of ROs have been selected.

In some example embodiments alone or in combination with other embodiments of different aspects of present disclosure, the selection is performed in a round robin fashion, when there is more than one RO or sequence of ROs to select from.

In some example embodiments alone or in combination with other embodiments of different aspects of present disclosure, selecting the sequence of ROs is fully performed before the first transmission of the first message with repetition.

In some example embodiments alone or in combination with other embodiments of different aspects of present disclosure, selecting the sequence of ROs is performed concurrently with the transmission of the first message with repetitions, wherein a repetition of the first message is transmitted after selecting the RO over which that repetition is to be transmitted and before selecting the RO for the transmission of the subsequent repetition of the first message, if any.

In some example embodiments alone or in combination with other embodiments of different aspects of present disclosure, ROs of the selected sequence of ROs occupy different time resources.

In some example embodiments alone or in combination with other embodiments of different aspects of present disclosure, the one or more cell-specific indicators are received from a network.

In some example embodiments alone or in combination with other embodiments of different aspects of present disclosure, the apparatus of the first aspect is, or is comprised in user equipment.

According to a second example aspect of the present disclosure, there is provided an apparatus comprising means for performing:
defining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions; and
providing the defined one or more cell-specific indicators to user equipment, UE, for UE to determine and select a sequence of ROs among the candidate sequences of ROs for transmission of the first message with repetitions.

In some example embodiments alone or in combination with other embodiments of different aspects of present disclosure, the apparatus of the second aspect is, or is comprised in a network element. The network element may be for example a gNB. The network element may be a physical device or a virtualized network function comprising one or more virtual machines (VMs) that are for instance running on a virtualization platform comprising one or more virtualization servers.

In some example embodiments alone or in combination with other embodiments of different aspects of present disclosure, the repetition configuration groups multiple ROs in different frequency/time instances together to form the one or more candidate sequences of ROs.

In some example embodiments alone or in combination with other embodiments of different aspects of present disclosure, the repetition configuration comprises density parameters for generating one or more random sparse matrices for determining connections from one RO to subsequent ROs of the candidate sequences of ROs.

In some example embodiments alone or in combination with other embodiments of different aspects of present disclosure, the repetition configuration comprises one or more sparse matrices providing information on whether an RO is part of a candidate sequence of ROs or not.

In some example embodiments alone or in combination with other embodiments of different aspects of present disclosure, the repetition configuration comprises one or more combinatorial indicators providing the rank of one or more combinations of ROs out of all the possible combinations of ROs, wherein one combination indicates one candidate sequence of ROs.

In some example embodiments alone or in combination with other embodiments of different aspects of present disclosure, the repetition configuration comprises a first binary sequence indicating the first ROs of the candidate sequences of ROs and a second binary sequence indicating groups of ROs where the remaining ROs of the candidate sequences of ROs are located.

In some example embodiments alone or in combination with other embodiments of different aspects of present disclosure, the repetition configuration comprises N*M bits for each configured candidate sequence of ROs, wherein N is the number of ROs in the candidate sequences of ROs and each group of M bits indicate one RO in each group of consecutive ROs.

In some example embodiments alone or in combination with other embodiments of different aspects of present disclosure, the candidate sequences of ROs have at least one of the following in common: the first RO or the last RO, and the repetition configuration comprises single indication(s) of the common RO(s) and sequence specific indications of other ROs of the candidate sequences of ROs.

In some example embodiments alone or in combination with other embodiments of different aspects of present disclosure, the one or more cell-specific indicators comprise a preamble configuration of more than one preamble for transmission of the first message with repetitions for a UE to select a preamble for transmission of the first message with repetitions.

In some example embodiments alone or in combination with other embodiments of different aspects of present disclosure, the one or more cell-specific indicators comprise a maximum time configuration for a UE to determine maximum time duration for transmission of the first message with repetitions.

In some example embodiments alone or in combination with other embodiments of different aspects of present disclosure, the random access procedure is contention based random access, CBRA.

In some example embodiments alone or in combination with other embodiments of different aspects of present disclosure, the means of the apparatus of the first aspect and/or the second aspect comprises at least one processor; and at least one memory including executable instructions that, when executed by the at least one processor, cause the performance of the apparatus.

According to a third example aspect of the present disclosure, there is provided a method, comprising:
obtaining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions;
using the repetition configuration to determine and select a sequence of ROs among the candidate sequences of ROs for transmission of the first message with repetitions; and
using the selected sequence of ROs for transmission of the first message with repetitions.

According to a fourth example aspect of the present disclosure, there is provided a method, comprising
defining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions; and
providing the defined one or more cell-specific indicators to user equipment, UE, for UE to determine and select a sequence of ROs among the candidate sequences of ROs for transmission of the first message with repetitions.

According to a fifth example aspect of the present disclosure, there is provided computer executable program instructions configured to cause performing at least the following:
obtaining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions;
using the repetition configuration to determine and select a sequence of ROs among the candidate sequences of ROs for transmission of the first message with repetitions; and
using the selected sequence of ROs for transmission of the first message with repetitions.

According to a sixth example aspect of the present disclosure, there is provided computer executable program instructions configured to cause performing at least the following:
defining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions; and
providing the defined one or more cell-specific indicators to user equipment, UE, for UE to determine and select a sequence of ROs among the candidate sequences of ROs for transmission of the first message with repetitions.

The computer program of the fifth and/or the sixth example aspect may be stored in a non-transitory computer readable memory medium.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

According to a seventh example aspect of the present invention, there is provided an apparatus comprising at least one processor and at least one memory storing instructions that, when executed by the processor, cause the apparatus to perform
obtaining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions;
using the repetition configuration to determine and select a sequence of ROs among the candidate sequences of ROs for transmission of the first message with repetitions; and
using the selected sequence of ROs for transmission of the first message with repetitions.

According to an eighth example aspect of the present disclosure, there is provided an apparatus comprising at least one processor and at least one memory storing instructions that, when executed by the processor, cause the apparatus to perform:
defining one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel, RACH, occasions, RO, for transmission of the first message with repetitions; and
providing the defined one or more cell-specific indicators to user equipment, UE, for UE to determine and select a sequence of ROs among the candidate sequences of ROs for transmission of the first message with repetitions.

Different non-binding example aspects and embodiments of the present invention have been illustrated in the foregoing. The embodiments in the foregoing are used merely to explain selected aspects or steps that may be utilized in implementations of the embodiment of the present disclosure. Some embodiments may be presented only with reference to certain example aspects. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a signaling diagram of a 4-step RACH procedure of 5G NR;

FIG. 2 shows an example of time-domain resource determination for RACH occasions;

FIG. 3 shows an example of SSB to RO mapping;

FIGS. 4-6 show flow charts of processes of some example embodiments;

FIG. 7 lists implementation alternatives of some example embodiments;

FIG. 8 is a graph presentation of some examples of RO sequences;

FIG. 9 shows a random sparse matrix of an example embodiment;

FIGS. 10A-10B illustrate details of some example embodiments; and

FIG. 11 shows a block diagram of an apparatus of an example embodiment.

### DETAILED DESCRIPTION OF SOME EXAMPLE EMBODIMENTS

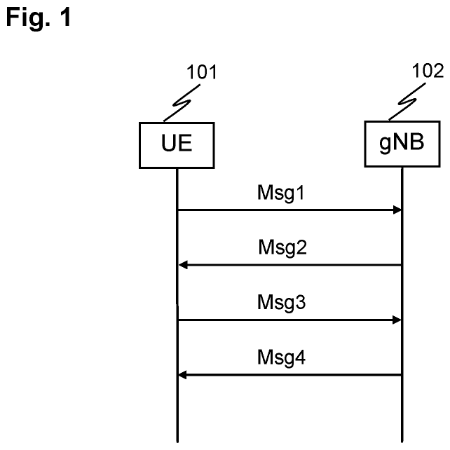

Example embodiments of the present disclosure and its potential advantages are understood by referring to FIGS. 1 through 11 of the drawings. In this document, like reference signs denote like parts or steps.

In the following, various example embodiments of present disclosure are discussed in detail in the context of 5G NR technology. It is however to be noted that various example embodiments of present disclosure may be equally applied to other mobile networks and radio communication technologies (e.g. future technologies, such as 6G technology or any subsequently developed technology) in addition to 5G NR.

In 5G NR, two contention based random access (CBRA) procedures are supported, namely 4-step random access channel (RACH) (Rel-15) and 2-step RACH (Rel-16). Present disclosure focuses on the 4-step RACH for illustration purpose and simplicity, but various example embodiments of present disclosure are equally applicable to the 2-step RACH.

FIG. 1 shows a signaling diagram of the 4-step RACH procedure of 5G NR. FIG. 1 shows a user equipment (UE) 101 and NR Node B (gNB) 102. The messages of the 4-step RACH procedure as shown in FIG. 1 can be summarized as follows:
First message Msg1 (a.k.a PRACH): The UE 101 sends a specific preamble to the gNB 102 via physical random access channel (PRACH) using a specific resource called RACH occasion (RO).
Second message Msg2 (a.k.a. RAR): The gNB 102 replies with a random access response (RAR) message, which includes a detected preamble ID, a time-advance command, a Temporary Cell RNTI, Radio Network Temporary Identifier (TC-RNTI), and UL grant for the transmission of a third message Msg3 on physical uplink shared channel (PUSCH).
Third message Msg3 (a.k.a. RRC request): The UE 101 responds to Msg2 over the scheduled PUSCH with an ID for contention resolution.
Fourth message Msg4 (a.k.a. RRC setup): The gNB 102 transmits the contention resolution message with the contention-resolution ID.

Upon reception of Msg4, the UE 101 sends an ACK on a PUCCH if its contention-resolution ID is carried by Msg4. This completes the 4-step RACH. It is worth noting that prior to Msg1, there is also a preliminary step of sending and receiving the synchronization signal block (SSB), i.e., DL beam sweeping, which is not formally part of the RACH procedure. As a result of this preliminary step, the UE 101 selects the index of the preferred SSB beam and decodes the associated physical broadcast channel (PBCH) for master information block (MIB), system information block (SIB) and so on. This index is also used by UE to identify a suitable RO for the preamble transmission (i.e. Msg1) according to the SSB-to-RO mapping implicitly conveyed by the SIB1.

The 2-step RACH is similar to the 4-step RACH as shown in FIG. 1, except that Msg1 and Msg3 are combined into a MsgA and sent out without waiting for feedback from the network in between (i.e. Msg2 of FIG. 1). Similarly, the gNB combines Msg2 and Msg4 into a MsgB. Various embodiments of present disclosure may be equally applied to Msg1 of FIG. 1 or to the preamble/Msg1 part of MsgA of the 2-step RACH.

In the following, configuration of RACH occasions (RO) is discussed for better understanding of various embodiments of present disclosure.

The time-domain resource for RACH occasions is configured via higher-layer signaling by prach-ConfigurationIndex (in rach-ConfigGeneric), which acts as an indicator to a row of a table specified in 3GPP specification TS 38.211 V17.3.0 (clause 6.3.3.2). With the parameters indicated by prach-ConfigurationIndex, the UE determines the preamble format for PRACH to find the ROs in time-domain as specified in 3GPP specifications.

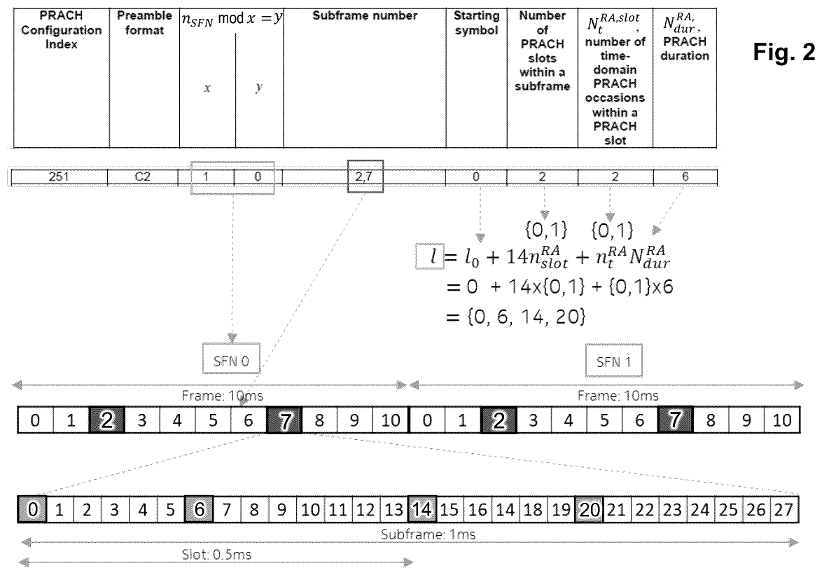

FIG. 2 shows an example of time-domain resource determination for RACH occasions. In the shown example, the prach-ConfigurationIndex is 251. With this index indicated, the UE determines the following:
Preamble format C2 should be used.
ROs are allocated at the system frame numbers (n_{SFN}) that satisfy n_{SFN} mod 1=0 (i.e. all SFN numbers are valid).
Within each of the determined SFNs, ROs are allocated at subframe number 2 and 7.
Within each of the determined subframes, the remaining parameters in the considered row indicate that ROs will start at symbol number 0, 6, 14, 20. The symbol number is continuously counted regardless of the number of slots within the subframe, which depends on the sub-carrier spacing configured for PRACH.
ROs duration is 6 symbols (although the actual duration of the preamble format can be less than that).

Finally, the validity of the determined ROs must be checked. An RO is determined as valid, if it is within UL symbols or if it has a sufficient gap after the last SSB/DL symbol in case it is within flexible symbols.

With regard to the frequency-domain, the parameters msg1-FrequencyStart and msg1-FDM configured in RACH-ConfigGeneric indicate the offset of the lowest RO in frequency domain and the number of ROs multiplexed in frequency domain for a group of back-to-back OFDM symbol, respectively. The number of occupied resource blocks (RB) per RO, expressed in number of RBs for PUSCH, is specified in the 3GPP specifications, depending on the configured preamble length and sub-carrier spacings for PRACH and PUSCH.

The mapping of SSB indices to the determined ROs is necessary for a UE to understand which ROs are associated to the SSB index selected during the preliminary step before the start of the RACH procedure. The different SSB indices are beamformed in different directions in the cell, hence selection of a wrong SSB index may entail failure of the RACH procedure.

To this purpose, a parameter ssb-perRACH-OccasionAndCB-PreamblesPerSSB is configured in RACH-ConfigCommon. This parameter indicates: (i) the number of SSB indices per RO, and (ii) the number of contention-based preambles per SSB index. Once this information is available to the UE, the UE maps the SSB indices to the time-frequency grid of ROs (determined as described above) in increasing order of frequency resource indices, time resource indices of the ROs within a PRACH slots, and the PRACH slots, sequentially.

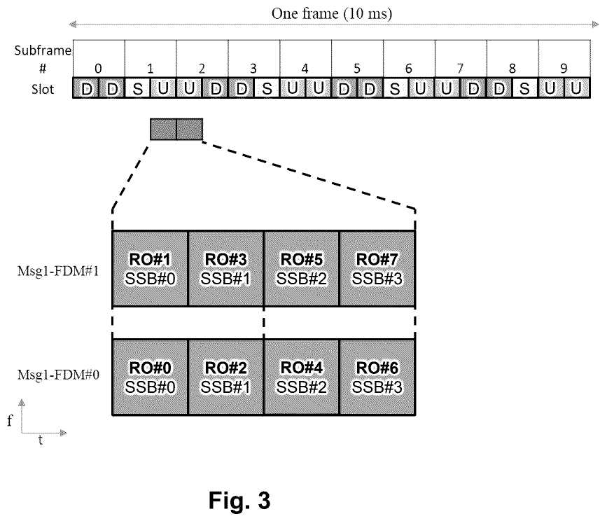

FIG. 3 shows an example of SSB-to-RO mapping. FIG. 3 illustrates an example of valid ROs in one frame determined as illustrated in FIG. 2. The following additional configuration is assumed: DDSUU slot structure, Msg1-FDM=two, and ssb-perRACH-OccasionAndCB-PreamblesPerSSB is one-half. Based on the configuration, two ROs are multiplexed in the frequency domain (Msg1-FDM=two) and any two FDM'd ROs are mapped to the same SSB index (ssb-perRACH-OccasionAndCB-PreamblesPerSSB=½).

4G LTE specifications include a Msg1 repetition feature to ensure Msg1 transmission to achieve improved coverage. The inventors of present disclosure have observed that the Msg1 repetition feature of 4G LTE is not straightforwardly applicable to 5G NR as there are differences between LTE and NR systems when it comes to radio air interface. 5G NR is based on a beam-based architecture which heavily relies on analog and/or digital beamforming. This was not the case in LTE, where beam management is more rudimentary.

There are some challenges that are related to Msg1 repetition feature in 5G NR context. Considering a 5G NR scenario in which gNB makes use of a certain number of analog/digital beams to serve the UEs and in which different UEs may repeat Msg1 a certain number of times without specific restrictions on Msg1 repetitions, Msg1 collisions are likely to happen. In such scenario, in the case of repetitions, the CE UE consumes a lot of time and energy, as compared to single Msg1 transmissions, for transmitting multiple (e.g. 4 or 8) Msg1 repetitions, which may span large time intervals to find out only at the end that a collision occurred at gNB side and Msg1 needs to be re-transmitted. This timeline becomes even longer when considering that UL slots may not be always contiguous (e.g. in a TDD system) and that multiple SSB indices (up to 64 in FR2) may be in use at the network. Therefore, collisions in Msg1 repetitions may cause huge delays in initial access and should be avoided particularly in case of low-SNR CE UE at cell-edge performing Msg1 repetitions. Further, assigning completely independent resources (i.e. preambles and ROs) for several UEs performing Msg1 repetitions is not always possible.

Further, it should be noted that temporary identities are assigned to UEs whose Msg1 transmission has been detected, only upon reception of Msg1 itself. Accordingly, gNB has no constructive means to distinguish two UEs repeating Msg1 even if dedicated resources were configured for the Msg1 repetitions, since such resources could only be cell-specific. This may hinder the realizability of coherent combining of multiple Msg1s at gNB, when multiple UEs attempt access with repetitions. This might degrade the performance of Msg1 transmission and reduce the practical usability of Msg1 repetitions.

The following discusses in detail various embodiments of present disclosure providing Msg1 repetition feature suited for 5G NR. The solution is to define in network one or more candidate sequences of ROs for transmission of the Msg1 with repetitions. The UE is then allowed to select a sequence of ROs among the candidate sequences.

For the sake of simplification for the purpose of detailed disclosure of some example embodiments, a group of back-to-back OFDM symbols are defined as a time instance, i.e., the time duration of one RO in a slot.

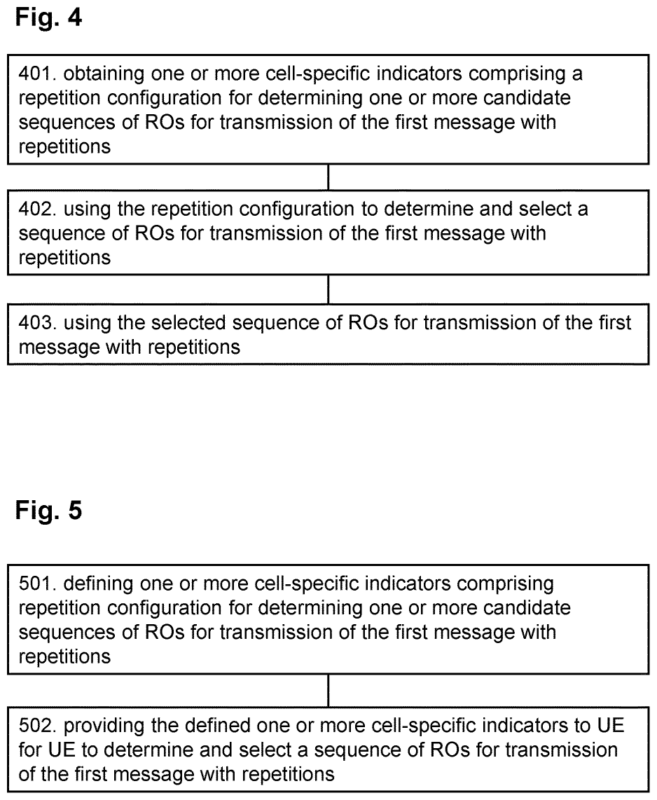

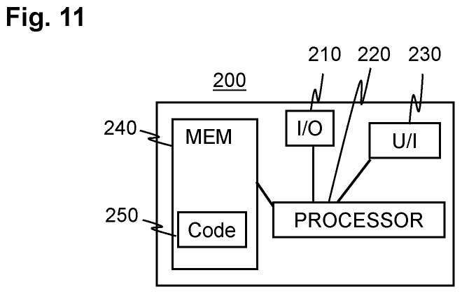

FIG. 4 shows a flow chart of a process of an example embodiment. The process may be implemented for example in a UE such as the UE 101 of FIG. 1 or in apparatus 1100 of FIG. 11. The process comprises the following steps:
Step 401: One or more cell-specific indicators are obtained. The cell-specific indicators comprise configuration for aspects of a RACH procedure that comprises transmission of a first message with repetitions. Further, the cell-specific indicators comprise a repetition configuration for determining one or more candidate sequences of ROs for transmission of the first message (Msg1) with repetitions. I.e. the repetition configuration defines one or more candidate sequences of ROs for UEs of the respective cell to choose from.

In general, the repetition configuration groups multiple ROs in different frequency/time instances together to form the one or more candidate sequences of ROs. The groupings may be provided as relationships between configured ROs via higher-layer parameters prach-ConfigurationIndex and ssb-perRACH-OccasionAndCB-PreamblesPerSSB.

According to example embodiments, the candidate sequences of ROs have the following characteristics:
ROs sharing the same time resources cannot be part of the same sequence.
ROs in a sequence are ordered according to their index (as per specification), e.g., first in increasing order of frequency resource index, second in increasing order of time resource index and third in increasing order of indices of PRACH slot.
Sequences may overlap, i.e., the same RO may be part of more than one sequence. An RO that is part of more than one candidate sequence corresponds to a node in graph for which multiple incoming and/or outgoing edges exist. This feature provides low collision probability with a minimum number of resources.

In an example embodiment, the one or more cell-specific indicators may further comprise a preamble configuration of more than one preamble for transmission of the first message with repetitions. The preamble configuration may be used in the UE to select a preamble for transmission of the first message with repetitions. In an example embodiment, the preambles for transmission of the first message with repetitions may be part of a reserved set, i.e., they cannot be selected by UEs not performing transmission of the first message with repetitions.

In an example embodiment, the one or more cell-specific indicators may further comprise a maximum time configuration. The maximum time configuration may be used in the UE to determine maximum time duration for transmission of the first message with repetitions. Details of implementation examples of the maximum time configuration are discussed later in this disclosure.

The cell-specific indicators may be provided to the UE from the network (e.g. gNB) e.g. by broadcasting or signaling this information in the respective cell. Such broadcasting or signaling may take place prior to a formal RACH procedure, e.g. in a preliminary step of sending and receiving the synchronization signal block (SSB) etc. The repetition configuration may be used by the UE in conjunction with higher-layer parameters prach-ConfigurationIndex and ssb-perRACH-OccasionAndCB-PreamblesPerSSB defined for RACH procedure.
Step 402: The repetition configuration is used to determine and select a sequence of ROs for transmission of the first message with repetitions.
Step 402 may be implemented by first determining all candidate sequences of ROs in accordance with the repetition configuration and then selecting one of the determined candidate sequences. Alternatively, an iterative process may be implemented without fully determining all possible candidate sequences. In such iterative process, one or more candidates for a first RO of the sequence are determined in accordance with the repetition configuration and one of the candidates is selected. Then, subsequent ROs are iteratively determined and selected until required number of ROs have been selected so that one or more subsequent candidates for a subsequent RO of the sequence are determined based on the previously selected RO and one of the determined subsequent candidates is selected. In this way, the selected sequence of ROs is fully determined whilst other candidate sequences are not necessarily determined as they are not necessarily needed at all. Whenever there is more than one RO or sequence of ROs to select from, the selection may be performed in a round robin fashion.
Step 402 may comprise using the repetition configuration in conjunction with the parameters prach-ConfigurationIndex and ssb-perRACH-OccasionAndCB-PreamblesPerSSB.

In accordance with an example embodiment, the ROs of the selected sequence of ROs occupy different time resources.
Step 403: The selected sequence of ROs is then used for transmission of the first message with repetitions in the RACH procedure.

It is to be noted that the selection of the sequence of ROs may be fully performed before the transmission of the first Msg1 repetition, i.e., the entire sequence of ROs to be used for transmitting N Msg1 repetitions is determined and selected by the UE before the start of the Msg1 transmission with repetitions. Alternatively, the selection of the sequence of ROs may be performed concurrently with transmission of N Msg1 repetitions, i.e. the first Msg1 repetition may be transmitted right after the first RO of the sequence has been selected (and before selecting the RO for the next Msg1 repetition, if there are more repetitions to be transmitted or at least before selecting the whole sequence of ROs).

FIG. 5 shows a flow chart of a process of an example embodiment. The process may be implemented for example in a network element such as the gNB of FIG. 1 or in apparatus 1100 of FIG. 11. The process comprises the following steps:
Step 501: One or more cell-specific indicators are defined. The cell-specific indicators comprise configuration for aspects of a RACH procedure that comprises transmission of a first message with repetitions. Further, the cell-specific indicators comprise a repetition configuration for determining one or more candidate sequences of ROs for transmission of the first message with repetitions. I.e. defining the one or more cell-specific indicators comprises defining one or more candidate sequences of ROs for UEs of the respective cell to choose from.

In an example embodiment, the one or more cell-specific indicators may further comprise a preamble configuration of more than one preamble for transmission of the first message with repetitions for a UE to select a preamble for transmission of the first message with repetitions.

In an example embodiment, the one or more cell-specific indicators may further comprise a maximum time configuration for a UE to determine maximum time duration for transmission of the first message with repetitions.

The maximum time configuration may be expressed as a function of a number of subframes, as a function of a number of system radio frames, as a function of a number of ROs, as a function of a number of OFDM symbols, and/or as a function of the PRACH configuration or association period.

In an example embodiment, the repetition configuration is defined in conjunction with parameters prach-ConfigurationIndex and ssb-perRACH-OccasionAndCB-PreamblesPerSSB defined for RACH procedure.

There may be multiple repetition configurations in a cell. For instance, this may be useful when more than one number of Msg1 repetitions is supported in the cell, e.g., N=2 and N=4 repetitions, or to provide additional diversity when only one value of N is supported in the cell. The choice would be up to the network, wherein one or several cell-specific parameters may be defined to cover all possible supported numbers of repetitions or to provide higher diversity in the RO selection at the UE.
Step 502: The defined one or more cell-specific indicators are provided for use in UEs. This may be done by broadcasting the one or more cell-specific indicators in the cell. A UE in the cell may then determine and select a sequence of ROs for transmission of the first message with repetitions for the RACH procedure.

FIG. 6 shows a flow chart of a process of an example embodiment. The process may be implemented for example in a UE such as the UE 101 of FIG. 1 or in apparatus 1100 of FIG. 11. The process comprises the following steps:
Step 601: One or more cell-specific indicators are obtained. The cell-specific indicators comprise configuration for aspects of a RACH procedure that comprises transmission of a first message with repetitions. Further, the cell-specific indicators comprise repetition configuration for determining one or more candidate sequences of ROs for transmission of the first message with repetitions. The cell-specific indicator(s) may further comprise a preamble configuration and a maximum time configuration as discussed in connection with step 401 of FIG. 4 and step 501 of FIG. 5.
Step 602: The one or more cell-specific indicators are used for configuring RACH resources for transmission of the first message, Msg1, with repetitions and the following is determined:
candidate sequences of ROs for transmission of Msg1 with N repetitions within the configured maximum time duration, and
a preamble for transmission of Msg1 with N repetitions.
Step 603: It is checked if there are one or more determined candidate sequences.
Step 604: If it is concluded that there is one determined candidate sequence, the determined candidate sequence is selected, and transmission of Msg1 with N repetitions is performed using N ROs of the selected sequence.
Step 605: If it is concluded that there are more than one determined candidate sequences, it is checked if all determined candidate sequences share the same first (or last) RO.
Step 606: If it is concluded that all determined candidate sequences share the same first RO, the first RO common to all determined sequences is selected.
Step 607: If it is concluded that all determined candidate sequences do not share the same first RO, one of the ROs determined as first RO of a sequence is selected. The selection may be performed in a round robin fashion. The selection mechanism may be defined in the cell-specific indicators or hard-coded in the specification. When the first RO is not selected in a round robin fashion, different UEs can be separated at network e.g. by transmitted preamble.
Step 608: One of the possible next ROs following the selected first RO is selected. The selection may be performed in a round robin fashion. The selection mechanism may be defined in the cell-specific indicators or hard-coded in the specification.
Step 609: It is checked if N ROs have been selected. If it is concluded that N ROs have not been selected yet, the process returns to step 608 to select next RO.
Step 610: If it is concluded that N ROs have been selected, transmission of Msg1 with N repetitions is performed using sequence of N selected ROs.

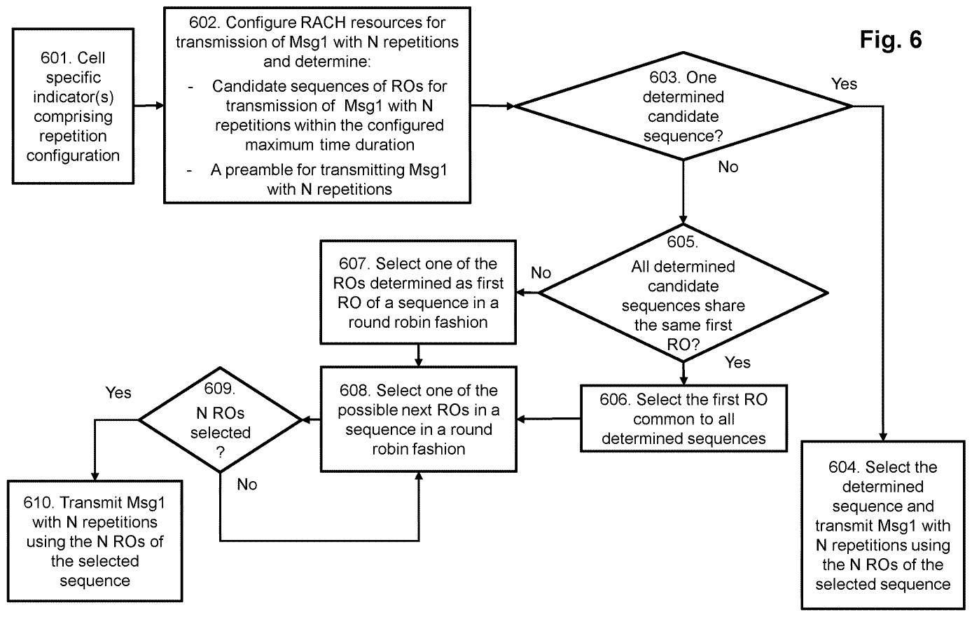

FIG. 7 is a graph presentation of some examples of candidate sequences of ROs. Therein each sequence of ROs is represented by a set of nodes connected by directed edges. The nodes are arranged in a matrix, wherein nodes in the same row share the same frequency resource and nodes in the same column share the same time resource. The index of the frequency resource occupied by the nodes increases from bottom-to-top, and the index of the time resource increases from left-to-right.

Three candidate sequences of ROs are shown in FIG. 7:
1. [RO #1 RO #6 RO #11 RO #13]
2. [RO #1 RO #6 RO #8 RO #13]
3. [RO #1 RO #4 RO #8 RO #13]

In a first practical example, the UE receives a cell-specific indicator comprising repetition configuration of the candidate sequences of FIG. 7. Based on the repetition configuration, the UE fully determines the three candidate sequences of ROs 1-3 and then selects one of the determined sequences, e.g. 1. [RO #1 RO #6 RO #11 RO #13].

In a second practical example, the UE receives a cell-specific indicator comprising repetition configuration of the candidate sequences of FIG. 7. Now, the UE does not determine the three sequences entirely, but determines at least one full sequence, which is the one that will be selected eventually, as follows:
UE determines and selects RO #1
UE determines RO #4 and RO #6 and selects RO #6
UE determines RO #8 and RO #11 and selects RO #11
UE determines and selects RO #13, thereby having selected the sequence 1. [RO #1 RO #6 RO #11 RO #13]

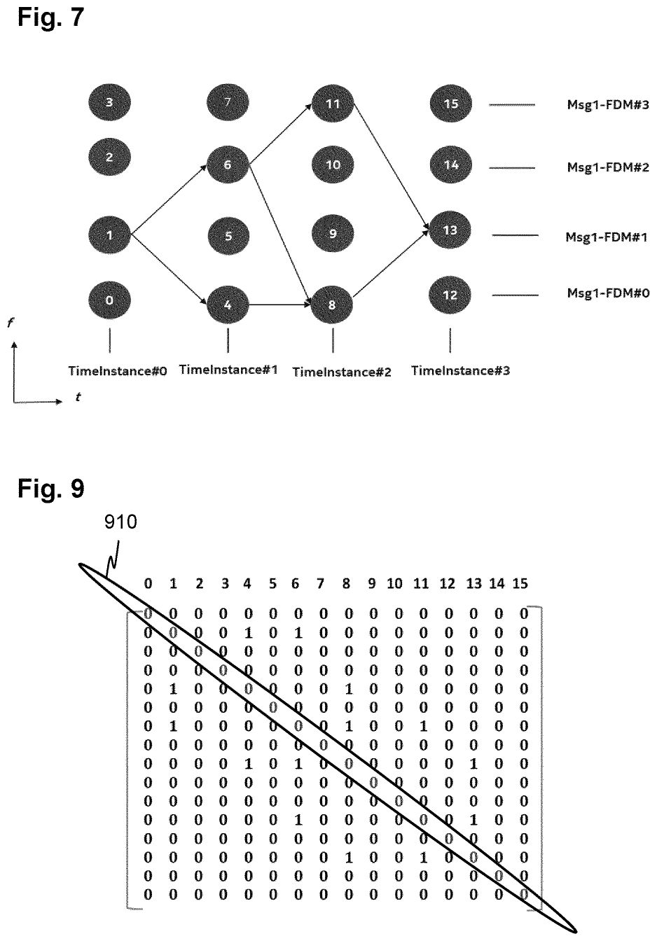

FIG. 8 lists implementation alternatives of some example embodiments. There are listed different alternatives that may be used for conveying the repetition configuration to the UE. Some of the listed alternatives may be combined or used in parallel.

Alternative 801: The repetition configuration comprises density parameters for generating one or more random sparse matrices for determining connections from one RO to subsequent ROs of the candidate sequences of ROs.

In this embodiment, the UE generates, based on the density parameters, one or more random sparse matrices or vectors that provide the connections from one RO to subsequent configured ROs associated with the same SSB index and within the configured maximum time duration for transmission of the first message with repetitions.

A sparse matrix/vector is a matrix/vector of ones and zeros, with a density of ones (number of ones among the total number of entries) equal to the configured density. To randomize the number of next ROs (e.g., edges in FIG. 7) in a sequence for each RO of the sequence (alt. node in FIG. 7), the sparse matrix/vector shall be randomly generated with a seed that depends at least on the time and frequency resource occupied by the RO(s) under consideration. Additionally, the seed could depend on the SSB index the RO is associated with. A set of one or more cell-specific seeds could also be configured by the network in order for the network to control which ROs are part of which sequence to a larger degree.

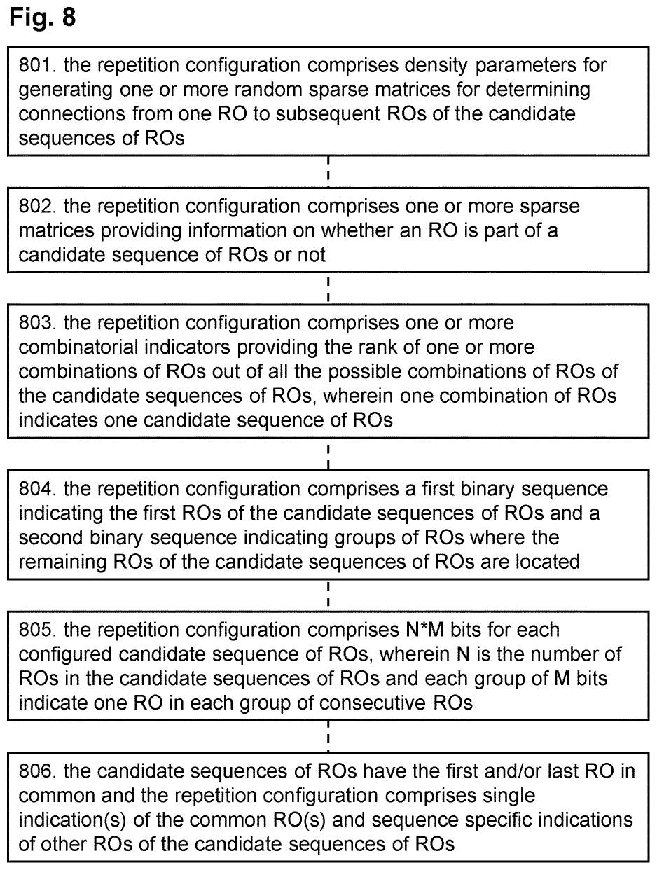

FIG. 9 shows a random sparse matrix of an example embodiment. The shown matrix is of size 16×16, with configured density equal to 6% (yielding 14 ones over 16×16 entries) related to 16 configured ROs (that may or may not be arranged in time and frequency as in FIG. 7) that may be part of a sequence of ROs, as per FIG. 7 (in which connected nodes are part of the same sequence).

In the example of FIG. 9 the bit corresponding to row 6 and column 11 is set to 1, representing a present connection between RO #11 and RO #6. Same rationale applies to the other ROs. Symmetrically, the bit corresponding to row 11 and column 6 is also set to 1. For this reason, the determination of ROs in each sequence does not require the indication of the entire matrix, but only of the part below or above its main diagonal 910.

As an alternative, in place of the sparse matrix, several sparse vectors can be generated, one per each RO in each sequence, to represent the next RO(s) in the one or more sequences including the considered RO, located in the next time instance. In particular, for each considered RO in a sequence, the number of next ROs in the next time instance is equal to the minimum number of sequences including the considered RO. In the example of FIG. 7, four (4) possible candidate next ROs in the sequence exist for each RO in a given time instance, and thus a random sparse vector of length 4 and configured density needs to be created per each RO in a sequence of ROs. In the example of FIG. 7, RO #1 is configured with a density of 0.5 (2 next ROs in the next time instance, i.e., RO #1 is included in at least 2 sequences) whereas, for example, RO #4 is configured with a density of 0.25 (1 next RO in the next time instance, i.e., RO #4 is included in at least one sequence.

In an example implementation, only one density value is configured for generation of the sparse matrix or vectors. Depending on the total number of sequences network wishes to configure, and on the number of overlaps between them (i.e., the same RO belongs to two or more sequences), the density value will be different and require fewer or more bits for lower and larger maximum number of sequences including the considered RO. Considering the case of a sparse matrix, for instance, and a quantization of the matrix density with steps of 10% (e.g. [10%, 20%, . . . 100%]), 10 states need to be represented by the density value, which would require a total of 4 bits for configuring it.

Alternative 802: The repetition configuration comprises one or more sparse matrices providing information on whether an RO is part of a candidate sequence of ROs or not.

In this embodiment, the repetition configuration is provided in the form of the sparse matrix or vectors providing information on whether an RO is part of a sequence or not. The information is provided, if applicable, for each configured ROs associated to the same SSB index and within the configured maximum time duration for transmission of the first message with repetitions irrespective of whether the RO is actually part of a sequence or not. The interpretation of the configuration is the same as in the alternative 801.

Considering that only half of the matrix is necessary for indicating all the configured sequences, a total of 128 bits is needed for 16 configured ROs associated to the same SSB index and within the configured maximum time duration for transmission of the first message with repetitions (16*16/2).

Even though this approach requires a larger number of bits than the alternative 801, it has the advantage of giving the possibility of fully controlling the connection among the ROs through the repetition configuration.

Alternative 803: The repetition configuration comprises one or more combinatorial indicators providing the rank of one or more combinations of ROs out of all the possible combinations of ROs of the candidate sequences of ROs, wherein one combination of ROs indicates one candidate sequence of ROs.

In this embodiment, each sequence of N ROs (for transmission of the first message with N repetitions) out of the K consecutive ROs associated with same SSB beam are ordered according to their index (determined as per specification). The combinatorial indicator provides the rank of one combination out of all the possible combinations of N ROs out K ROs to transmit the first message with N repetitions. One combinatorial indicator indicates one sequence of N ROs in K consecutive ROs using

$$⌈ {log}_{2} ( \begin{matrix}K \\ N\end{matrix} ) ⌉$$

bits. If L>1 sequences are configured by the network, each sequence is indicated independently using the rank of the corresponding combination, and the overall bitwidth of the combinatorial indicator for all sequences is

$$L ⌈ {log}_{2} ( \begin{matrix}K \\ N\end{matrix} ) ⌉$$

bits.

In the example of FIG. 7, three (3) sequences of 4 nodes/ROs out of 16 nodes/ROs are represented (and thus are configured to the UE). This requires only 33 bits.

Alternative 804: The repetition configuration comprises a first binary sequence indicating the first ROs of the candidate sequences of ROs and a second binary sequence indicating groups of ROs where the remaining ROs of the candidate sequences of ROs are located.

In this embodiment, K consecutive ROs associated with same SSB beam are ordered according to their index (determined as per specification), and are grouped in

$$⌈ \begin{matrix}K \\ N\end{matrix} ⌉$$

groups of at most F consecutive ROs. In this context, F may be the number of ROs in the same time instance, or alternatively a parameter signaled by the network with an additional indicator. Each RO in a group of F consecutive ROs is represented by a binary sequence of M=┌log₂ F┐ bits. The network indicates at least one RO in the first group of F consecutive ROs by using a first binary sequence of at least M bits. The UE may then determine valid RO sequences by determining the remaining ROs of each sequence of ROs out of the remaining groups of F consecutive ROs. The remaining groups of F consecutive ROs can be back-to-back and subsequent to the first group of F consecutive ROs or the network can additionally indicate a second binary sequence of T N bits for indicating the remaining groups of F consecutive ROs where the remaining ROs are located. The latter may require the network to indicate the value of T, unless it is hardcoded in specification. In one example embodiment, for each considered RO in the sequence, the next RO(s) in the sequence (located in any subsequent group(s) of F consecutive ROs) is/are associated with binary sequence(s) that differ from the one associated with current RO by only a bits, i.e., Hamming distance=a.

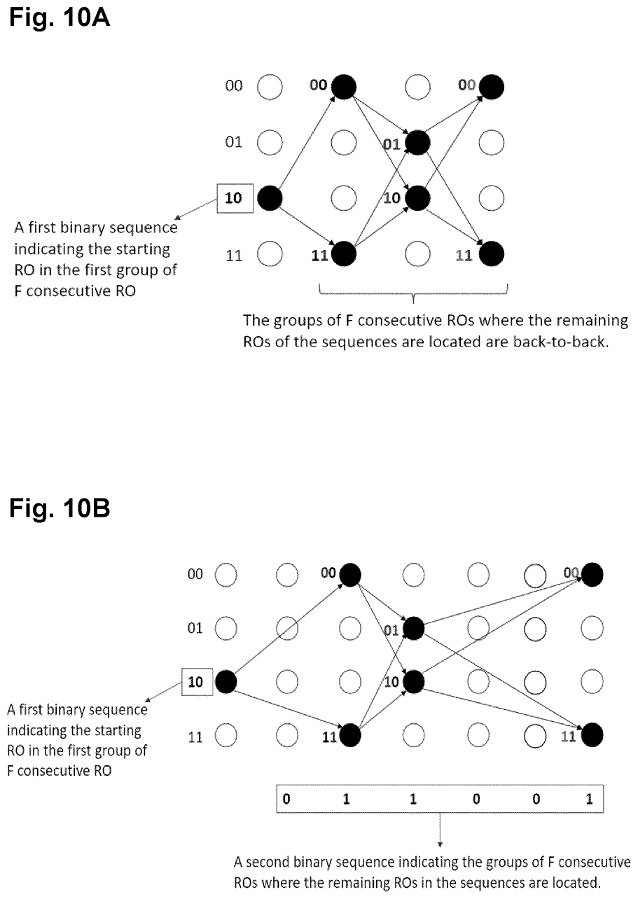

FIGS. 10A-10B illustrate details of some example embodiments of the alternative 804.

Example of FIG. 10 A: The number of ROs in a group of consecutive ROs is 4 (i.e., F=4), i.e., M=┌log₂ F┐=2 bits are needed to represent each RO in each group of F=4 consecutive ROs (it is assumed that F equals to the number of ROs in a time instance in this example). It is assumed that the initial RO indicated by the network in the first group of F consecutive ROs is associated with a first binary sequence 10 and assuming that α=1 (i.e., minimum Hamming distance). In addition, it is assumed that the remaining groups of F consecutive ROs are back-to-back and subsequent to the first group of F consecutive ROs in this example. Then the next valid ROs in the second group of F consecutive ROs (second column as per example in FIG. 10 A) are the ROs associated with the binary sequences 00 and 11 (differ from 10 by only 1 bit). Similarly, starting from the valid ROs associated with the sequence 00, the next valid ROs in the third group of F consecutive ROs (third column) are the ROs associated with the binary sequences 01 and 10. The same method is applied for each valid RO until reaching the maximum number of ROs per sequence (N). A total bitwidth of 2 bits is needed in this example.

Example of FIG. 10 B: The number of ROs in a group of consecutive ROs is 4 (i.e., F=4), i.e., M=┌log₂ F┐=2 bits are needed to represent each RO in each group of F=4 consecutive ROs (it is assumed that F equals to the number of ROs in a time instance in this example). It is assumed that the initial RO indicated by gNB in the first group of F consecutive ROs is associated with a first binary sequence 10 and that α=1 (i.e., minimum Hamming distance). In addition, it is assumed that the network also indicates a second binary sequence of T=6 bits for indicating the groups of F consecutive ROs where the remaining ROs are located. Each bit in the second binary sequence indicates whether a corresponding group of subsequent F consecutive ROs includes one of the remaining ROs or not. For instance, if such binary sequence is [0 1 1 0 0 1] as shown in FIG. 10 B, the groups of F consecutive ROs including the remaining ROs of the sequences are the 3^{rd}, 4^{th}, and 7^{th} groups of F consecutive ROs (or the 3^{rd}, 4^{th}, and 7^{th} columns as per example in FIG. 10 B). Then the method proceeds as follows. The next valid ROs in the 3^{rd} group of F consecutive ROs (3^{rd} column) are the ROs associated with the binary sequences 00 and 11 (differ from 10 by only 1 bit). Similarly, starting from the valid RO associated with the binary sequence 00, the next valid ROs in the 4^{th} group of F consecutive ROs (4^{th} column) are the ROs associated with the binary sequences 01 and 10. The same method is applied for each valid RO until reaching the number of ROs per sequence (N). This example requires 2+6=8 bits for indicating the first and second binary sequences and additionally the bits for indicating value of T, e.g.,

$$⌈ \begin{matrix}K \\ N\end{matrix} ⌉ - 1$$

bits may be needed for indicating T (if T is not hardcoded in the specification). Therefore, a total bitwidth of

$$⌈ \frac{K}{F} ⌉ + 7 = 10$$

bits is needed in this example.

Alternative 805: The repetition configuration comprises N*M bits for each configured candidate sequence of ROs, wherein N is the number of ROs in the candidate sequences of ROs and each group of M bits indicate one RO in each group of consecutive ROs.

In this embodiment, the network indicates each sequence of N ROs using N*M bits, wherein each group of M=┌log₂ F┐ bits indicate one RO in each group of F consecutive ROs (which could, for instance, correspond to a node in a column of FIG. 7, assuming that F equals to the number of ROs in a time instance in this example).

The following discusses an example of the alternative 805: In the scenario of FIG. 7, N=4 and M=┌log₂ F┐=2. Thus, each sequence of ROs in FIG. 7 is indicated by 4*2=8 bits, wherein each group of 2 bits indicate one RO in the sequence of ROs. For instance, the highest, middle and lowest path/sequence of ROs can be represented by [10 01 00 10], [10 01 11 10], and [10 11 11 10], respectively, which requires a bitwidth of 3*8=24 bits to be signaled. Additionally, ┌log₂ F┐ bits would be necessary in case the parameter F needs to be configured and signaled by the network.

The alternative 805 may be particularly convenient when the number of ROs in the same time instance is larger than 1.

Alternative 806: The candidate sequences of ROs have the first and/or last RO in common and the repetition configuration comprises single indication(s) of the common RO(s) and sequence specific indications of other ROs of the candidate sequences of ROs.

In this embodiment, all sequences of N ROs share the same first and/or last RO. Such ROs are indicated only once, and only ROs other than such common ROs are indicated via the indicator of each sequence.

The following discusses an example of the alternative 805: In FIG. 7, all the sequences of ROs share the same first and last RO, both associated with the binary sequence 10. The network then needs 4 bits to indicate the two common ROs and 4 bits to indicate the remaining ROs for each sequence of ROs. Therefore, the network only needs to indicate the following sequences (the order can differ) [10], [10], [01 00], [01 11] and [11 11], for indicating the two common ROs, and all the remaining ROs of all sequences, yielding 16 bits in total.

The following discusses another example of the alternative 805: In FIG. 10 A, all the sequences of ROs share the same first RO, associated with the binary sequence 10. The network then needs 2 bits to indicate the common RO and 6 bits for indicating the remaining ROs for each sequence of ROs. Therefore, the network only needs to indicate the following sequences (the order can differ) [10], [00 01 00], [00 10 00], [00 01 11], [00 10 11], [11 01 00], [11 01 11], [11 10 00][11 10 11], for indicating the first common RO, and all the remaining ROs of all sequences, yielding 50 bits in total.

FIG. 11 shows a block diagram of an apparatus 1100 according to an example embodiment. The apparatus 1100 may operate as a network element, such as the gNB 102 of FIG. 1, or as a UE, such as the UE 101 of FIG. 1. The apparatus 1100 generally comprises a memory 1140 including a computer program code 1150. The apparatus 1100 further comprises a processor 1120 for controlling the operation of the apparatus 1100 using the computer program code 1150, and a communication unit 1110 for communicating with other nodes. Further, the apparatus 1100 may comprise a user interface unit 1130.

The communication unit 1110 comprises, for example, one or more of: a local area network (LAN) port; a wireless local area network (WLAN) unit; Bluetooth unit; cellular data communication unit; or satellite data communication unit. The communication interface 1110 may support one or more different communication technologies. The communication interface 1110 may support Ethernet communications and/or IP based communications. The apparatus 1100 may also or alternatively comprise more than one of the communication interfaces 1110. The processor 1120 comprises, for example, any one or more of: a master control unit (MCU); a microprocessor; a digital signal processor (DSP); an application specific integrated circuit (ASIC); a field programmable gate array; and a microcontroller. The user interface unit 1130 may comprise a circuitry for receiving input from a user of the apparatus 1100, e.g., via a keyboard; graphical user interface of a display; speech recognition circuitry; or an accessory device; such as a headset; and for providing output to the user via, e.g., a graphical user interface or a loudspeaker. Various parts may be implemented using more than one corresponding or different elements, such as memories and storages may be multiplied for capacity and/or redundancy purposes. Similarly, processing and/or communications may be implemented with multiple parallel or elements for capacity and/or redundancy purposes.

The computer program code 1150 may control the apparatus 1100 to implement one or more example embodiments of present disclosure, such as the processes of FIGS. 4-6 and further details discussed in connection with FIGS. 7-9, and 10A-10B.

As used in this application, the term “circuitry” may refer to one or more or all of the following:
(a) hardware-only circuit implementations (such as implementations in only analog and/or digital circuitry) and;
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Without in any way limiting the scope, interpretation, or application of the claims appearing below, a technical effect of one or more of the example embodiments disclosed herein is improved random access procedure. Another technical effect of one or more of the example embodiments disclosed herein is providing details of random access procedure suited for 5G NR. More specifically, various embodiments provide configuration and determination of the RACH resources for Msg1 repetitions in a manner suited for 5G NR.

Yet another technical effect of one or more of the example embodiments disclosed herein is that they may reduce the collision probability among UEs in coverage shortage performing Msg1 repetitions. Yet another technical effect of one or more of the example embodiments disclosed herein is that the detection complexity at the receiver (to distinguish between UEs) may be reduced, e.g. in comparison to a system in which UEs can choose ROs randomly with no structured approach to RO determination and selection. Various example embodiments provide that the number of blind decoding instances may be lower than in some other approaches. Yet another technical effect of one or more of the example embodiments disclosed herein is that practical usability of the Msg1 repetition feature may be increased. Yet another technical effect of one or more of the example embodiments disclosed herein is that the amount of resources needed for Msg1 repetitions is not excessively increased.

Embodiments of the present disclosure may be implemented in software, hardware, application logic or a combination of software, hardware, and application logic. The software, application logic and/or hardware may reside e.g. on the gNB 102 or on the UE 101. In an example embodiment, the application logic, software, or an instruction set is maintained on any one of various conventional computer-readable media. In the context of this document, a “computer-readable medium” may be any non-transitory media or means that can contain, store, communicate, propagate, or transport the instructions for use by or in connection with an instruction execution system, apparatus, or device, such as a computer, with one example of a computer described and depicted in FIG. 11. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined.

Although various aspects of present disclosure are set out in the independent claims, other aspects may comprise other combinations of features from the described embodiments and/or the dependent claims with the features of the independent claims, and not solely the combinations explicitly set out in the claims.

It is also noted herein that while the foregoing describes example embodiments, these descriptions should not be viewed in a limiting sense. Rather, there are several variations and modifications which may be made without departing from the scope of the present disclosure as defined in the appended claims.

### List of Abbreviations

UE: User Equipment
gNB: NR Node B
Msg1: Message 1
PRACH: Physical Random Access Channel
RACH: Random Access Channel
RO: RACH Occasion
FDM: Frequency Domain Multiplexing
SS/PBCH: Synchronization Signal/Physical Broadcast Channel
SSB: Synchronization Signal Block
FR1: Frequency Range 1
FR2: Frequency Range 2
SIB1: System Information Block 1
TDD: Time Division Duplexing
FDD: Frequency Division Duplexing
OFDM: Orthogonal Frequency Division Multiplexing
CE: Coverage Enhanced

1-24. (canceled)

25. An apparatus comprising at least one processor and at least one memory, said at least one memory stored with computer program code thereon, the at least one memory and the computer program code configured to, with the at least one processor, cause the apparatus at least to:
obtain one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel (RACH) occasions (RO) for transmission of the first message with repetitions;
use the repetition configuration to determine and select a sequence of ROs among the candidate sequences of ROs for transmission of the first message with repetitions; and
use the selected sequence of ROs for transmission of the first message with repetitions.

26. The apparatus of claim 25, wherein determining and selecting the sequence of ROs is performed by using the repetition configuration to determine the candidate sequences of ROs for transmission of the first message with repetitions; and
select one of the determined candidate sequences of ROs.

27. The apparatus of claim 25, wherein determining and selecting the sequence of ROs is performed by
use the repetition configuration to determine one or more candidates for a first RO of the sequence and selecting one of the candidates as the first RO of the sequence; and
iteratively determine one or more subsequent candidates for a subsequent RO of the sequence based on the previously selected RO of the sequence and selecting one of the subsequent candidates as the subsequent RO of the sequence until required number of ROs have been selected.

28. The apparatus of claim 25, wherein when there is more than one RO or sequence of ROs to select from, the selection is performed in a round robin fashion.

29. The apparatus of claim 25, wherein selecting the sequence of ROs is fully performed before the first transmission of the first message with repetition.

30. The apparatus of claim 25, wherein selecting the sequence of ROs is performed concurrently with the transmission of the first message with repetitions, wherein a repetition of the first message is transmitted after selecting the RO over which that repetition is to be transmitted and before selecting the RO for the transmission of the subsequent repetition of the first message, if any.

31. The apparatus of claim 25, wherein ROs of the selected sequence of ROs occupy different time resources.

32. The apparatus of claim 25, wherein the one or more cell-specific indicators are received from a network.

33. The apparatus of claim 25, wherein the apparatus is, or is comprised in user equipment.

34. An apparatus comprising at least one processor and at least one memory, said at least one memory stored with computer program code thereon, the at least one memory and the computer program code configured to, with the at least one processor, cause the apparatus at least to:
define one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel (RACH) occasions (RO) for transmission of the first message with repetitions; and
provide the defined one or more cell-specific indicators to user equipment, UE, for UE to determine and select a sequence of ROs among the candidate sequences of ROs for transmission of the first message with repetitions.

35. The apparatus of claim 34, wherein the apparatus is, or is comprised in a network element.

36. The apparatus of claim 34, wherein the repetition configuration groups multiple ROs in different frequency/time instances together to form the one or more candidate sequences of ROs.

37. The apparatus of claim 34, wherein the repetition configuration comprises density parameters for generating one or more random sparse matrices for determining connections from one RO to subsequent ROs of the candidate sequences of ROs.

38. The apparatus of claim 34, wherein the repetition configuration comprises one or more sparse matrices providing information on whether an RO is part of a candidate sequence of ROs or not.

39. The apparatus of claim 34, wherein the repetition configuration comprises one or more combinatorial indicators providing the rank of one or more combinations of ROs out of all the possible combinations of ROs, wherein one combination indicates one candidate sequence of ROs.

40. The apparatus of claim 34, wherein the repetition configuration comprises a first binary sequence indicating the first ROs of the candidate sequences of ROs and a second binary sequence indicating groups of ROs where the remaining ROs of the candidate sequences of ROs are located.

41. The apparatus of claim 34, wherein the repetition configuration comprises N*M bits for each configured candidate sequence of ROs, wherein N is the number of ROs in the candidate sequences of ROs and each group of M bits indicate one RO in each group of consecutive ROs.

42. The apparatus of claim 34, wherein the candidate sequences of ROs have at least one of the following in common: the first RO or the last RO, and the repetition configuration comprises single indication(s) of the common RO(s) and sequence specific indications of other ROs of the candidate sequences of ROs.

43. The apparatus of claim 34, wherein the one or more cell-specific indicators comprise a preamble configuration of more than one preamble for transmission of the first message with repetitions for a UE to select a preamble for transmission of the first message with repetitions.

44. A method, comprising:
obtain one or more cell-specific indicators, wherein the cell-specific indicators comprise configuration for aspects of a random access procedure that comprises transmission of a first message with repetitions, wherein the cell-specific indicators comprise a repetition configuration for determining one or more candidate sequences of random access channel (RACH) occasions (RO) for transmission of the first message with repetitions;
use the repetition configuration to determine and select a sequence of ROs among the candidate sequences of ROs for transmission of the first message with repetitions; and
use the selected sequence of ROs for transmission of the first message with repetitions.
